(19) United States
(12) Patent Application Publication
(10) Pub. No.: US 2026/0331777 A1
(43) Pub. Date: Oct. 22, 2026

(54) FREQUENCY SELECTIVE SURFACE

(71) Applicant: Panasonic Intellectual Property Management Co., Ltd., Kadoma-shi, Osaka (JP)

(72) Inventors: Mikiya Fujita, Osaka Fu (JP); Kota Araki, Osaka Fu (JP); Kenji Shibata, Osaka Fu (JP)

(73) Assignee: Panasonic Intellectual Property Management Co., Ltd., Kadoma-shi, Osaka (JP)

(21) Appl. No.: 19/106,878

(22) PCT Filed: Sep. 7, 2023
(86) PCT No.: PCT/JP2023/032731

§ 371 Date: Feb. 26, 2025

(30) Foreign Application Priority Data
Sep. 12, 2022 (JP) 2022-144401

(51) Int. Cl. H01Q 15/00

(52) U.S. Cl. CPC H01Q 15/0026

(57) ABSTRACT

In a first region of a substrate, the first cells adjacent to each other are electrically continuous with each other. The overall size of a first conductor pattern is smaller than the wavelength of electromagnetic waves entering a frequency selective surface and is a size capable of reflecting the wavelength. In a second region of the substrate, second conductive lines forming second cells adjacent to each other are not electrically continuous with each other. A second conductor pattern is configured such that the size of each second cell is smaller than the overall size of the first conductor pattern and is a size capable of transmitting the wavelength of the electromagnetic waves.

### DESCRIPTION

### Technical Field

The present disclosure relates to a frequency selective surface.

### Background Art

Frequency selective surfaces as those disclosed, for example, in Patent Document 1 and Patent Document 2 have been known as frequency selective surfaces for use to control the radio environment and the electromagnetic environment.

Patent Document 1 discloses a frequency selective surface including a dielectric substrate and a plurality of first conductive patterns formed on one surface of the dielectric substrate. Each of the plurality of first conductive patterns is configured as a unit cell. The unit cells are spaced apart from one another on the surface of the dielectric substrate. Each unit cell has at least one conductor portion.

Patent Document 2 discloses a frequency selective surface (an electromagnetic shielding member) including a transparent insulative substrate and a conductive layer member located on the substrate. The conductive layer member includes a first conductive layer that can reflect electromagnetic waves selectively. The first conductive layer is configured as a metal mesh including thin metal wires with a predetermined line width and having a plurality of square openings. The conductive layer member further includes a non-conductive portion that can transmit electromagnetic waves selectively (see FIG. 7 of Patent Document 2). The non-conductive portion is located inside the first conductive layer, and is a portion where a cross shape is cut out of the metal mesh.

### CITATION LIST

### Patent Document

Patent Document 1: WO2021/009893
Patent Document 2: WO2021/131962

### SUMMARY OF THE INVENTION

### Technical Problem

The one surface of the dielectric substrate of the frequency selective surface of Patent Document 1 has a region with the plurality of first conductive patterns and a region without the plurality of first conductive patterns. The substrate of the frequency selective surface of Patent Document 2, too, has a region with the first conductive layer and a region without the first conductive layer (i.e., a region with the non-conductive portion). In other words, according to the frequency selective surfaces of the above documents, the state of distribution of the conductive patterns on the substrate is not uniform.

Thus, for example, if the frequency selective surfaces disclosed in the above documents are attached to a window of a building (a flat or curved window surface), the region with a conductive pattern and the region without the conductive pattern are distinguished from each other more easily when the window is viewed from the inside or outside of the building. In other words, when the window is viewed from the inside or outside of the building, only the conductor portions forming the conductive patterns (corresponding to the thin metal wires in Patent Document 2), for example, are conspicuous. Accordingly, the appearance of the frequency selective surface deteriorates depending on the use conditions, which causes a problem that the visibility of the frequency selective surface is impaired.

Patent Document 2 also discloses another configuration of the non-conductive portion where the metal mesh is oxidized in a cross shape, as an alternative of the non-conductive portion where a cross shape is cut out of the metal mesh. However, the oxidized metal mesh of this configuration is difficult to recognize visually, and only the first conductive layer is conspicuous as a result. Thus, there has been a problem that depending on the use conditions, the visibility of the frequency selective surface is impaired in the configuration in which the metal mesh is oxidized in the cross shape, as well, similarly to the configuration in which the cross shape is cut out of the metal mesh.

In view of the foregoing background, it is therefore an object of the present disclosure to ensure the function for providing appropriate control of electromagnetic waves and obtain a frequency selective surface with better visibility.

### Solution to the Problem

In order to achieve the above object, an embodiment of the present disclosure is directed to a frequency selective surface. The frequency selective surface includes: a substrate having a first region and a second region; at least one first conductor pattern arranged in the first region of the substrate, the at least one first conductor pattern including a plurality of first cells, each of the first cells being formed by a plurality of first conductive lines; and at least one second conductor pattern arranged in the second region of the substrate, the at least one second conductor pattern including a plurality of second cells, each of the second cells being formed by a plurality of second conductive lines. The plurality of first cells are configured such that the first cells adjacent to each other are electrically continuous with each other. The at least one first conductor pattern is configured such that an overall size of the first conductor pattern is smaller than a wavelength of electromagnetic waves entering the frequency selective surface and is a size capable of reflecting the wavelength of the electromagnetic waves. The plurality of second cells are configured such that the second conductive lines forming the second cells adjacent to each other are not electrically continuous with each other. The at least one second conductor pattern is configured such that a size of each of the second cells is smaller than the overall size of the first conductor pattern and is a size capable of transmitting the wavelength of the electromagnetic waves.

### Advantages of the Invention

According to the present disclosure, it is possible to ensure the function for providing appropriate control of electromagnetic waves and obtain a frequency selective surface with better visibility.

### BRIEF DESCRIPTION OF THE DRAWINGS

FIG. 1 is a plan view illustrating the entirety of a frequency selective surface according to an embodiment of the present disclosure.

FIG. 2 is a partially enlarged plan view of a portion II of FIG. 1.

FIG. 3 is a partially enlarged plan view of a portion III of FIG. 2.

FIG. 4 is a cross-sectional view taken along line IV-IV of FIG. 2.

FIG. 5 is a graph schematically showing the measurement results of reference examples from the viewpoint of how the relationship between the frequency of electromagnetic waves and transmission loss appears with or without a second region.

FIG. 6 corresponds to FIG. 2 and illustrates first and second conductor patterns according to a first variation of the embodiment.

FIG. 7 corresponds to FIG. 2 and illustrates first and second conductor patterns according to a second variation of the embodiment.

FIG. 8 corresponds to FIG. 2 and illustrates first and second conductor patterns according to a third variation of the embodiment.

FIG. 9 corresponds to FIG. 2 and illustrates first and second conductor patterns according to a fourth variation of the embodiment.

FIG. 10 corresponds to FIG. 2 and illustrates first and second conductor patterns according to a fifth variation of the embodiment.

FIG. 11 corresponds to FIG. 2 and illustrates a first conductor pattern, a second conductor pattern, and a third conductor pattern according to a sixth variation of the embodiment.

FIG. 12 corresponds to FIG. 2 and illustrates a first conductor pattern, a second conductor pattern, and a third conductor pattern according to a seventh variation of the embodiment.

### DESCRIPTION OF EMBODIMENTS

Embodiments of the present disclosure will be described below in detail with reference to the drawings. The following description of the embodiments is merely exemplary in nature and is not intended to limit the present disclosure, its application, or its uses.

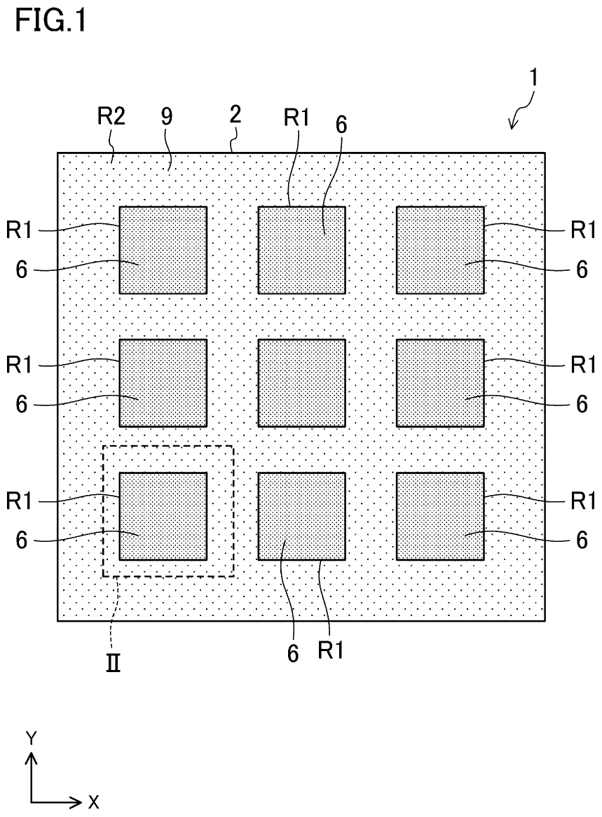

FIG. 1 illustrates an entire configuration of a frequency selective surface (FSS) 1 according to an embodiment of the present disclosure. The frequency selective surface 1 is used to control the radio environment and the electromagnetic environment. Specifically, the frequency selective surface 1 can be attached to a window of a building to control electromagnetic waves entering the inside of the building from the outside, for example.

To “control” as used herein means to reflect and/or transmit selectively the electromagnetic waves which have a predetermined frequency and propagate through a space. In the following description, electromagnetic waves entering the frequency selective surface 1 are simply referred to as “electromagnetic waves.”

In this embodiment, for the convenience of description, the direction from the left to the right of the sheet of FIG. 1 is defined as a first direction X, and the direction from the bottom to the top of the sheet of FIG. 1 is defined as a second direction Y.

### Substrate

As illustrated in FIG. 1, the frequency selective surface 1 includes a substrate 2. The substrate 2 has a substantially square shape in a plan view. The substrate 2 is formed in a film shape.

The substrate 2 has a plurality (nine in the illustrated example) of first regions R1 and one second region R2.

Each of the plurality of first regions R1 is set as a region capable of reflecting the electromagnetic waves selectively. Specifically, each first region R1 is capable of reflecting the electromagnetic waves entering from the front side of the sheet of FIG. 1 (or from the back side of the sheet of FIG. 1) toward the frequency selective surface 1, toward the front side of the sheet of FIG. 1 (or toward the back side of the sheet of FIG. 1). The plurality of first regions RI are spaced apart from one another on the substrate 2. The plurality of first regions R1 are aligned along each of the first direction X and the second direction Y. Each first region R1 has a substantially square shape. In FIG. 1, in order to clearly show the first regions R1, the first regions R1 are thickly dot-hatched.

The second region R2 is set as a region capable of transmitting the electromagnetic waves selectively. Specifically, the second region R2 is capable of transmitting the electromagnetic waves entering from the front side of the sheet of FIG. 1 (or from the back side of the sheet of FIG. 1) toward the frequency selective surface 1, toward the back side of the sheet of FIG. 1 (or toward the front side of the sheet of FIG. 1). The second region R2 is a region of the substrate 2 other than the plurality of first regions R1. In FIG. 1, in order to distinguish the first regions R1 and the second regions R2 from one each other, the second region R2 is dot-hatched thinly as compared to the first regions R1.

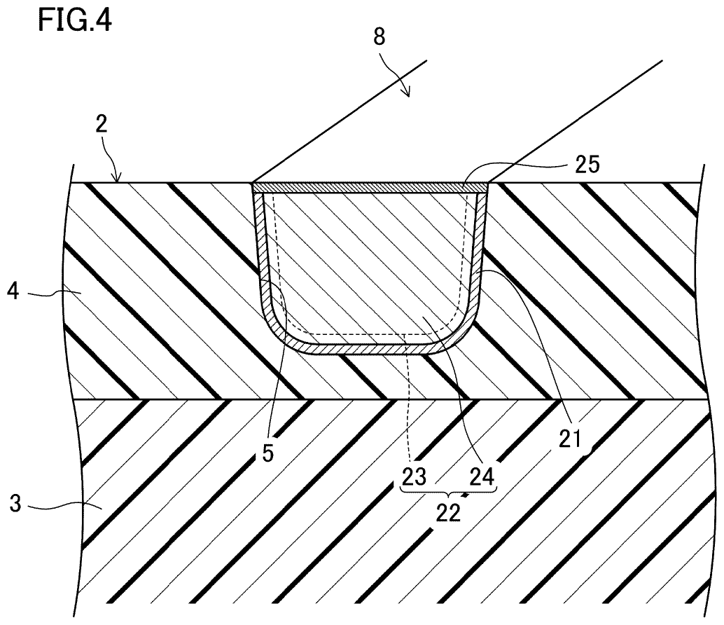

As illustrated in FIG. 4, the substrate 2 has a film base 3. The film base 3 is made of a resin material with transparency. Examples of this resin material include resin materials such as polyethylene terephthalate (PET), polycarbonate, cycloolefin polymer (COP), and cycloolefin copolymer (COC).

As illustrated in FIG. 4, the substrate 2 has a groove forming layer 4. The groove forming layer 4 is a layer for forming a plurality of recessed grooves 5, which will be described later. The groove forming layer 4 is made of a resin material with insulating properties and transmittance. The groove forming layer 4 is stacked on one surface of the film base 3. The groove forming layer 4 has a thickness ranging from 1.0 μm to 7.0 μm, for example.

As illustrated in FIG. 4, the substrate 2 has the plurality of recessed grooves 5. The plurality of recessed grooves 5 linearly extend on one surface of the substrate 2 and form a predetermined pattern, which will be described later.

Each recessed groove 5 is formed in a bottomed shape recessed in a thickness direction of the substrate 2 (in a direction from the groove forming layer 4 toward the film base 3). The depth of each recessed groove 5 is set to be 0.3 μm or more and 5.0 μm or less, for example. The recessed groove 5 is configured to have a groove width dimension of 10 μm or less.

The corner between each side surface and the bottom surface of the recessed groove 5 is filleted. The corner does not have to be filleted. The side surfaces of the recessed groove 5 may be inclined so that the opening gradually increases from the bottom surface of the recessed groove 5.

### First Conductor Pattern

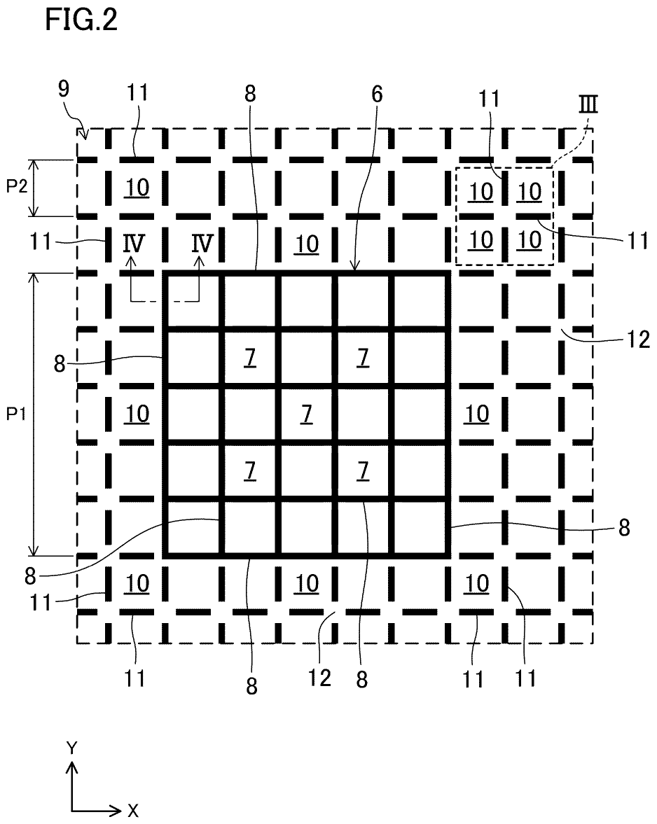

As illustrated in FIGS. 1 and 2, the frequency selective surface 1 includes a plurality of first conductor patterns 6. The first conductor patterns 6 are disposed on the associated first regions R1 of the substrate 2. The plurality of first conductor patterns 6 are spaced apart from one another on the substrate 2. Each first conductor pattern 6 has a substantially square shape in a plan view. The first conductor pattern 6 has a mesh structure in which a plurality of first cells 7, described later, are arranged regularly (see FIG. 2). In FIG. 1, for convenience of illustration, the illustration of the detailed configuration of the first conductor pattern 6 is omitted.

As illustrated in FIG. 2, each first conductor pattern 6 has the plurality of first cells 7. Each of the plurality of first cells 7 is formed by a plurality of first conductive lines 8.

Each first conductive line 8 extends along the first direction X or along the second direction Y. The plurality of first conductive lines 8 are arranged at predetermined intervals (at equal intervals in the illustrated example) in the first direction X or in the second direction Y. The line width of the first conductive line 8 is set to be 10 μm or less, for example.

Each first cell 7 is formed in a closed shape. Each first cell 7 of this embodiment has a substantially square shape. The plurality of first cells 7 are configured such that the first cells 7, 7 adjacent to each other are electrically continuous with each other.

The first conductor patterns 6 are configured such that the overall size of each first conductor pattern 6 is smaller than the wavelength of the electromagnetic waves entering the frequency selective surface 1 and is a size capable of reflecting the wavelength of the electromagnetic waves.

Here, the length of one side of the square shape forming the first conductor pattern 6 is defined as a dimension P1 illustrated in FIG. 2. The dimension P1 corresponds to the length of the first conductive lines 8. The dimension P1 is set to be 1/10 of the wavelength of the electromagnetic waves, for example.

As a specific example of the dimension P1, if the electromagnetic waves have a frequency of, for example, 28 GHz (i.e., a wavelength of the electromagnetic waves is about 1 cm), the dimension P1 is set to be 1 mm corresponding to 1/10 of the wavelength of the electromagnetic waves. The conductor resistance of the respective first conductive lines 8 is relatively low if the dimension is set to be such a dimension P1 (that is, to the overall size of each of the first conductor patterns 6 having a square shape, the length of one side of which is the dimension P1). This configuration makes each first conductive line 8 have greater reflection effect on the electromagnetic waves. In other words, it is possible to enhance the reflection effect of the first conductor patterns 6 on the electromagnetic waves.

### Second Conductor Pattern

As illustrated in FIGS. 1 and 2, the frequency selective surface 1 includes one second conductor pattern 9. The second conductor pattern 9 is disposed on the second region R2 of the substrate 2. The second conductor pattern 9 surrounds the first conductor patterns 6 (see FIG. 1). The second conductor pattern 9 has a mesh structure in which a plurality of second cells 10, described later, are arranged regularly (see FIG. 2). In FIG. 1, for convenience of illustration, the illustration of the detailed configuration of the second conductor pattern 9 is omitted.

As illustrated in FIG. 2, the second conductor pattern 9 has the plurality of second cells 10. In this embodiment, each second cell 10 is formed in a non-closed shape with slits 12, which will be described later. Each second cell 10 has a substantially square shape, for example.

Each second cell 10 is formed by a plurality of second conductive lines 11. The second cell 10 is formed mainly by four second conductive lines 11 independent of one another. The second conductive lines 11 extend along the first direction X or along the second direction Y. The plurality of second conductive lines 11 are arranged at predetermined intervals (at equal intervals in the illustrated example) in the first direction X or in the second direction Y.

In the vicinity of the outer periphery the first conductor pattern 6, each second cell 10 is formed by a portion of one of the first conductive lines 8 and by three second conductive lines 11. The second cells 10 in the vicinity of the outer periphery of the first conductor pattern 6 and the first cells 7 on the outer periphery of the first conductor pattern 6 are not electrically continuous with one another by the slits 12, which will be described later.

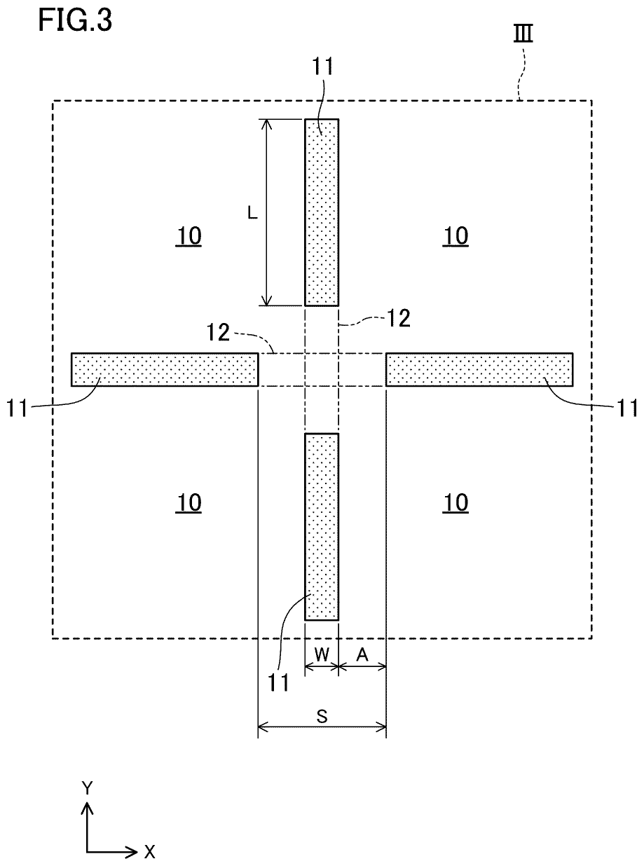

As illustrated in FIGS. 2 and 3, a slit 12 is formed between the second conductive lines 11, 11 adjacent to each other. The slit 12 is formed between the second conductive lines 11, 11 adjacent to each other in the first direction X and between the second conductive lines 11, 11 adjacent in the second direction Y. In this embodiment, the slits 12 are located at positions corresponding to the corners of the substantially square shape forming each second cell 10. Thus, in the second cells 10, 10 adjacent to each other, the second conductive lines 11, 11 are arranged with their end portions arranged at predetermined intervals. The length of the slit 12 (the dimension S illustrated in FIG. 3) is set to be greater than the line width of the second conductive line 11 (the dimension W illustrated in FIG. 3). In FIG. 3, the slits 12 are virtually shown using the dash-dot-dot lines.

In this embodiment, the slits 12 described above allow the plurality of second conductive lines 11 to be independent of one another. This configuration makes the second cells 10, 10 adjacent to each other not electrically continuous with each other. In other words, the second conductor pattern 9 is configured as a so-called “dummy pattern.” Further, since the second conductor pattern 9 has the slits 12 described above, the second conductor pattern 9 is superior in the transmission effect on the electromagnetic waves to the first conductor patterns 6.

The slits 12 are also formed between each of the first conductive lines 8 on the outer periphery of the first conductor pattern 6 and the second conductive lines 11 of the second cells 10 in the vicinity of the outer periphery of the first conductor pattern 6. This configuration makes the first conductive lines 8 and the second conductive lines 11 not electrically continuous with each other. In other words, the first conductor pattern 6 and the second conductor pattern 9 are not electrically continuous with each other.

The second conductor pattern 9 is configured such that the size of each second cell 10 is smaller than the overall size of the first conductor pattern 6 and is a size capable of transmitting the wavelength of the electromagnetic waves.

The length of one side of the substantially square shape forming the second cell 10 is defined as a dimension P2 illustrated in FIG. 2. This dimension P2 corresponds to the space between the second conductive lines 11, 11 facing each other in the first direction X or in the second direction Y. The length (the dimension L illustrated in FIG. 3) of the second conductive line 11 is shorter than the length (the dimension P2) of one side of the substantially square shape forming the second cell 10. Specifically, the second conductive line 11 is configured to have a length (dimension L) that is 1/50 or less of the wavelength of the electromagnetic waves. The length (dimension L) of the second conductive line 11 is set to be a length more preferably of 1/100 or less of the wavelength of the electromagnetic waves.

As a specific example of the length of each second conductive line 11, if the electromagnetic waves have a frequency of 28 GHz (i.e., a wavelength of the electromagnetic waves is about 1 cm), the length (the dimension L) of the second conductive line 11 is set to be 100 μm corresponding to 1/100 of the wavelength of the electromagnetic waves. The conductor resistance of the respective second conductive lines 11 is relatively high if the length of each second conductive line 11 is set to be such a length (that is, to the size of the second cell 10 formed by the plurality of second conductive lines 11). This configuration makes each second conductive line 11 have greater transmission effect on the electromagnetic waves. As a result, the transmission effect of the second conductor pattern 9 on the electromagnetic waves is enhanced.

If the conductor resistance is relatively low, and the volume of the conductor is relatively high, the number of free electrons in the conductor relatively increases, resulting in a greater effect on the electromagnetic waves. In other words, it results in a greater reflection effect on the electromagnetic waves. On the other hand, if the conductor resistance is relatively high, and the volume of the conductor is relatively low, the number of free electrons in the conductor relatively decreases, resulting in a smaller action on the electromagnetic waves. In other words, it results in a smaller transmission effect on the electromagnetic waves.

As illustrated in FIG. 3, it is preferable to set the space between the end of the second conductive line 11 extending along the first direction X and the second conductive line 11 extending along the second direction Y (i.e., the dimension A illustrated in FIG. 3) to be 1 μm or more in the first direction X. Similarly to this, it is preferable to set the space between the end of the second conductive line 11 extending along the second direction Y and the second conductive line 11 extending along the first direction X to be 1 μm or more in the second direction Y. If the shortest distance between the second conductive lines 11, 11 orthogonal to each other is set to be 1 μm or more, the higher the frequency of the electromagnetic waves, the more the transmittance of the electromagnetic waves through the second conductor pattern 9 can be increased.

To ensure sufficient transparency, each of the first conductor patterns 6 and the second conductor pattern 9 is configured to have a total light transmittance of 70% or more. Each of the second conductive lines 11 is configured to have a line width (dimension W illustrated in FIG. 3) of 10 μm or less. The second conductive line 11 may have the same line width as the line width of the first conductive lines 8. The “total light” described above may be visible rays.

### Sectional Structure of First and Second Conductive Lines

As illustrated in FIG. 4, each of the first conductive lines 8 includes an adhesive layer 21, a conductive layer 22, and a blackened layer 25. Although not shown, similarly to the first conductive line 8, each second conductive line 11 includes an adhesive layer 21, a conductive layer 22, and a blackened layer 25. In this embodiment, the main component of the conductive material forming the conductive layer 22 of the first conductive line 8 is the same as the main component of the conductive material forming the conductive layer 22 of the second conductive line 11.

The adhesive layer 21 is an element for ensuring the adhesion of the conductive layer 22 to the recessed groove 5. The adhesive layer 21 is, for example, a metal layer made of a metal nitride or a metal oxide containing at least one metal selected from the group consisting of Ti, Al, V, W, Ta, Si, Cr, Ag, Mo, Cu, and Zn. The adhesive layer 21 may be a single layer or a multilayer obtained by stacking a plurality of layers with different compositions. The adhesive layer 21 is stacked as a thin film on the recessed groove 5 by vapor deposition or sputtering, for example.

The conductive layer 22 is an element for ensuring the conductivity of the first conductive lines 8 and the second conductive lines 11. The conductive layer 22 is embedded in the recessed groove 5. The conductive layer 22 includes a seed layer 23 and a body layer 24. Both the seed layer 23 and the body layer 24 are made of a conductive material. Suitable as the conductive material is a conductive metal such as copper (Cu) or silver (Ag). The conductive metal may be replaced with, for example, a conductive material with light transmittance, such as a conductive resin material, indium tin oxide, or tin oxide.

The seed layer 23 has the function of improving the adhesion between the adhesive layer 21 and the body layer 24. Specifically, the seed layer 23 functions as a cathode for layering a plating solution such as copper (Cu) on the adhesive layer 21 in, for example, electroplating for forming the body layer 24. The seed layer 23 is stacked as a thin film on the adhesive layer 21 by vapor deposition or sputtering, for example. If the body layer 24 is formed by a method other than the electroplating, no seed layer 23 may be provided.

The body layer 24 is formed by vapor deposition, sputtering, electroless plating, or electroplating, for example. In this embodiment, the body layer 24 is stacked on the seed layer 23 by electroplating. After the electroplating, the seed layer 23 and the body layer 24 are integral so that the interface between the seed layer 23 and the body layer 24 is invisible.

The blackened layer 25 is stacked on the conductive layer 22 on the opening side of the recessed groove 5. The blackened layer 25 has a thickness of, for example, 7 nm to 10 nm. The blackened layer 25 has the function of making the first conductive lines 8 and the second conductive lines 11 less visible when the frequency selective surface 1 is viewed from outside.

The blackened layer 25 is formed by crystal grains of copper being substituted with palladium (by blackening), where the crystal grains of copper are located at boundaries (so-called “grain boundaries”) between the crystal grains of copper located on the surface of the conductive layer 22 (the body layer 24). Specifically, in the blackening, grain boundary corrosion progresses along the boundaries (grain boundaries) between the crystal grains of copper located on the surface of the body layer 24, and the crystal grains of copper forming the surface of the body layer 24 are substituted with palladium. The blackened layer 25 is stacked on the surface of the body layer 24 in this manner.

### [Advantageous Effects of Embodiment]

As described above, the plurality of first cells 7 are configured such that the first cells 7, 7 adjacent to each other are electrically continuous with each other. The first conductor patterns 6 are configured such that the overall size of each first conductor pattern 6 is smaller than the wavelength of the electromagnetic waves entering the frequency selective surface 1 and is a size capable of reflecting the wavelength. Thus, each of the first regions R1 where the first conductor pattern 6 is located can be configured as a region that can selectively reflect the electromagnetic waves having entered the frequency selective surface 1.

The plurality of second cells 10 are configured such that the second conductive lines 11, 11 forming the second cells 10, 10 adjacent to each other are not electrically continuous with each other. The second conductor pattern 9 is configured such that the size of each second cell 10 is smaller than the overall size of the first conductor pattern 6 and is a size capable of transmitting the wavelength of the electromagnetic waves. Thus, the second region R2 where the second conductor pattern 9 is located can be configured as a region that can selectively transmit the electromagnetic waves having entered the frequency selective surface 1.

Further, in the frequency selective surface 1, the first conductor patterns 6, of which the first cells 7, 7 are electrically continuous with each other, and the second conductor pattern 9 (i.e., dummy pattern), of which the second cells 10, 10 are not electrically continuous with each other, coexist on the substrate 2 as the first regions R1 and the second region R2. It is thus easier to make the state of distribution of the conductor patterns on the substrate 2 uniform. As a result, if the frequency selective surface 1 is attached to, for example, a window of a building, it is difficult to distinguish the first conductor patterns 6 and the second conductor pattern 9 (dummy pattern) from each other when the window is viewed from the inside or outside of the building. In other words, the phenomenon in which for example only the first conductor patterns 6 (the plurality of first conductive lines 8) are conspicuous is less likely to occur when the window is viewed from the inside or outside of the building. It is thus possible to improve the appearance of the frequency selective surface 1 under appropriate use conditions.

Thus, according to the embodiment of the present disclosure, it is possible to ensure the function for providing appropriate control of the electromagnetic waves and obtain the frequency selective surface 1 with better visibility.

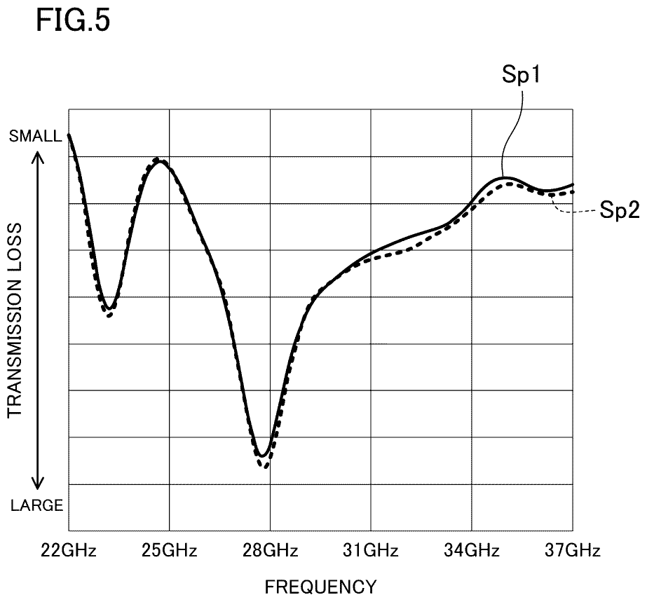

Here, FIG. 5 shows the results of measurement in reference examples by a so-called “free space method” (hereinafter referred to as the “measurement results of the reference examples”) from the viewpoint of how the relationship between the frequency of the electromagnetic waves and transmission loss appears with or without the second region R2 (with or without the second conductor pattern 9). The measurement example indicated by “Sp1” in FIG. 5 (hereinafter, referred to as the “measurement example Sp1”) is a measurement example relating to a configuration in which the substrate 2 has the first regions R1 and the second region R2 (i.e., a configuration corresponding to the frequency selective surface 1 according to the embodiment of the present disclosure). The measurement example indicated by “Sp2” in FIG. 5 (hereinafter, referred to as the “measurement example Sp2”) is a measurement example relating to a configuration in which the substrate 2 has only the first regions R1 (a different configuration from the frequency selective surface 1, not shown). In FIG. 5, in each of the measurement examples Sp1 and Sp2, the length of the first conductive lines 8 and/or the length of the second conductive lines 11 are/is set to be close to the frequency of the electromagnetic waves (“28 GHz” described above) at which frequency the transmission effect on the electromagnetic waves is lowest.

According to FIG. 5, there was not a large difference in the transmission loss (corresponding to the vertical axis in FIG. 5) between the measurement examples Sp1 and Sp2 around the frequency of the electromagnetic waves of 28 GHz. In other words, each of the measurement examples Sp1 and Sp2 had substantially the same transmission effect around the frequency of the electromagnetic waves of 28 GHz. Thus, the appearance similar to the configuration having only the first region R1 on the substrate 2 is obtainable in the configuration having the first regions R1 and the second region R2 on the substrate 2. Accordingly, it is possible to prove the better visibility of the frequency selective surface 1 based on the measurement results of the reference examples shown in FIG. 5, as well.

Each of the first conductor patterns 6 and the second conductor pattern 9 is configured to have a total light transmittance of 70% or more, and each of the second conductive lines 11 is configured to have a line width of 10 μm or less and a length that is 1/50 or less of the wavelength of the electromagnetic waves. This configuration allows appropriate transmission of the electromagnetic waves through the second region R2 while ensuring the transparency.

Further, the space between the end of the second conductive line 11 extending along the first direction X and the second conductive line 11 extending along the second direction Y (dimension A) is set to be 1 μm or more in the first direction X. According to this setting, the higher the frequency of the electromagnetic waves, the more the transmittance of the electromagnetic waves through the second conductor pattern 9 can be increased.

The substrate 2 is formed in a film shape. It is thus easy to attach the frequency selective surface 1 to a window of a building, for example.

Each of the first conductive lines 8 and the second conductive lines 11 includes the conductive layer 22 embedded in the recessed groove 5. The conductive layer 22 can ensure the conductivity of the first conductive lines 8 and the second conductive lines 11.

The main component of the conductive material forming the conductive layer 22 of the first conductive line 8 is the same as the main component of the conductive material forming the conductive layer 22 of the second conductive line 11. It is thus possible to reduce the manufacturing cost of the frequency selective surface 1.

Each of the first conductive lines 8 and the second conductive lines 11 further includes the blackened layer 25 stacked on the conductive layer 22 on the opening side of the recessed groove 5. The blackened layer 25 makes the first conductive lines 8 and the second conductive lines 11 less visible when the frequency selective surface 1 is viewed from outside.

### [First Variation of Embodiment]

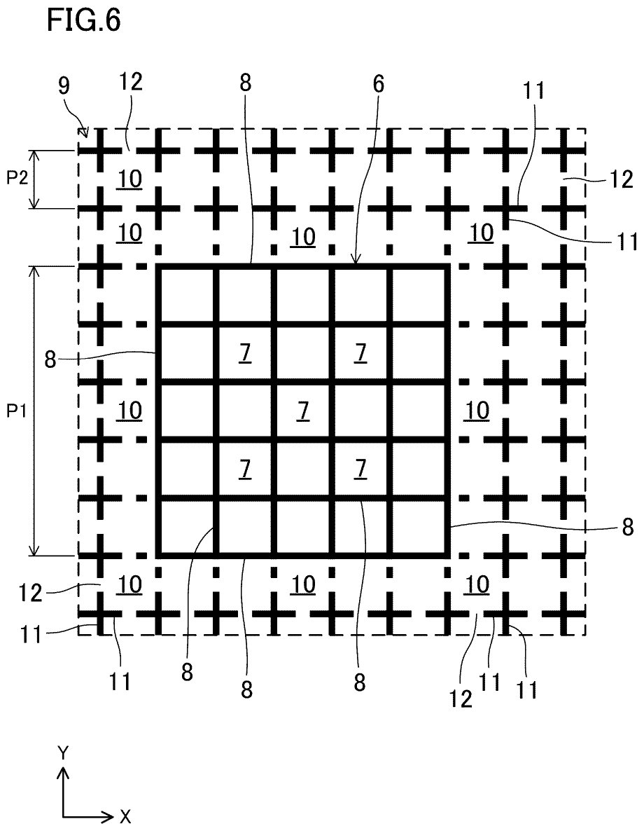

In the foregoing embodiment, the slits 12 are located at positions corresponding to the corners of the substantially square shape forming each second cell 10, but are not limited thereto. For example, as in a first variation illustrated in FIG. 6, a slit 12 may be positioned at an intermediate portion of each side of a substantially square shape forming the second cell 10. In other words, in this variation, the second conductive line 11 extending along the first direction X and the second conductive line 11 extending along the second direction Y intersect each other (in a so-called “cross shape”).

Even if the slits 12 are positioned as described above, the plurality of second conductive lines 11 are independent of one another as in the foregoing embodiment. In other words, the second conductive lines 11, 11 forming the second cells 10, 10 adjacent to each other are not electrically continuous with each other. Thus, the second conductor pattern 9 can be configured as a dummy pattern. Further, having the slits 12, even the second conductor pattern 9 of this variation is superior in the transmission effect on the electromagnetic waves to the first conductor patterns 6.

### [Second Variation of Embodiment]

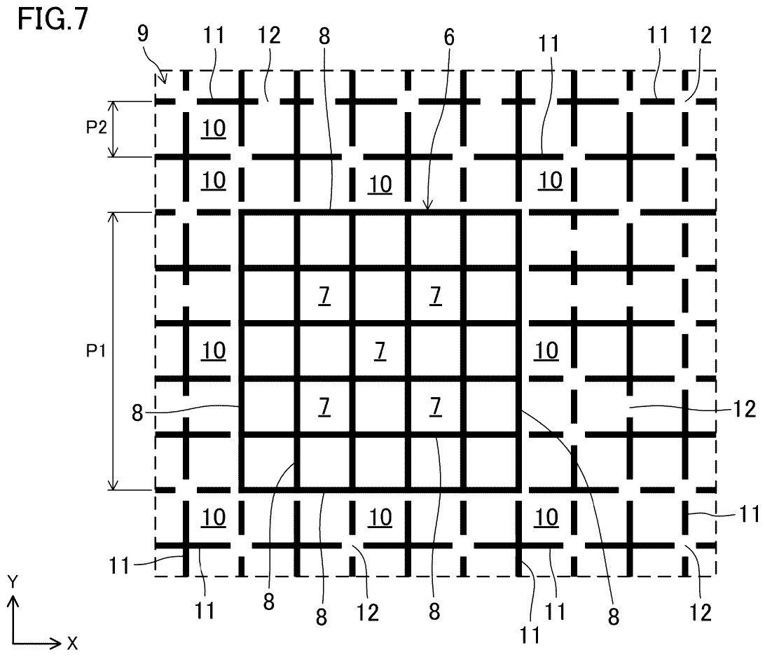

As in a second variation illustrated in FIG. 7, slits 12 may be located at positions corresponding the corners of the substantially square shape forming the second cell 10 and at intermediate portions of the sides of the substantially square shape. Even in this variation, the second conductor pattern 9 can be configured as a dummy pattern similarly to the foregoing embodiment and the first variation. Further, having the slits 12, even the second conductor pattern 9 of this variation is superior in the transmission effect on the electromagnetic waves to the first conductor patterns 6.

### [Third Variation of Embodiment]

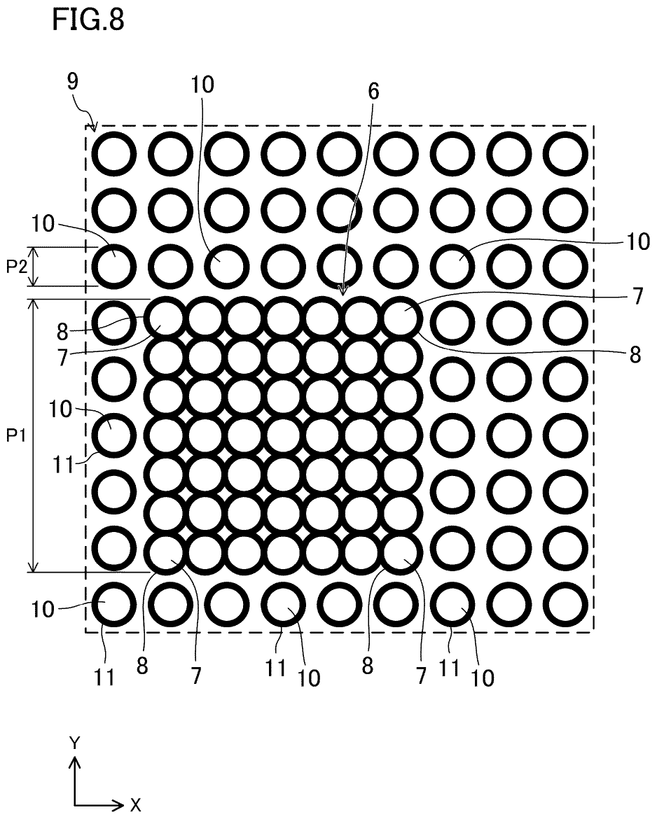

In the foregoing embodiment, the first cells 7 and the second cells 10 are substantially square, but are not limited thereto. For example, as in a third variation illustrated in FIG. 8, the first cells 7 and the second cells 10 may have a substantially circular shape.

In this variation, the first cells 7, 7 adjacent to each other are arranged such that the peripheries of the substantially circular shapes are in contact with each other. In other words, the first cells 7, 7 adjacent to each other are electrically continuous with each other. Thus, similarly to the foregoing embodiment, each of the first regions R1 where the first conductor pattern 6 is located can be configured as a region that can reflect the electromagnetic waves selectively.

In the foregoing embodiment, the second cells 10 are not closed due to the slits 12, but are not limited thereto. For example, as in the third variation, the second cells 10 may be closed. Specifically, in the third variation, no slit 12 is formed, and the plurality of second cells 10 each formed in a closed shape are spaced apart from one another. Even in such a configuration, the plurality of second conductive lines 11 are independent of one another as in the foregoing embodiment. In other words, the second cells 10, 10 adjacent to each other are not electrically continuous with each other. Thus, the second conductor pattern 9 can be configured as a dummy pattern. Further, the second conductor pattern 9 of this variation is superior in the transmission effect on the electromagnetic waves to the first conductor pattern 6, because the second cells 10, 10 are spaced apart from one another in the second conductor pattern 9 of this variation.

### [Fourth and Fifth Variations of Embodiment]

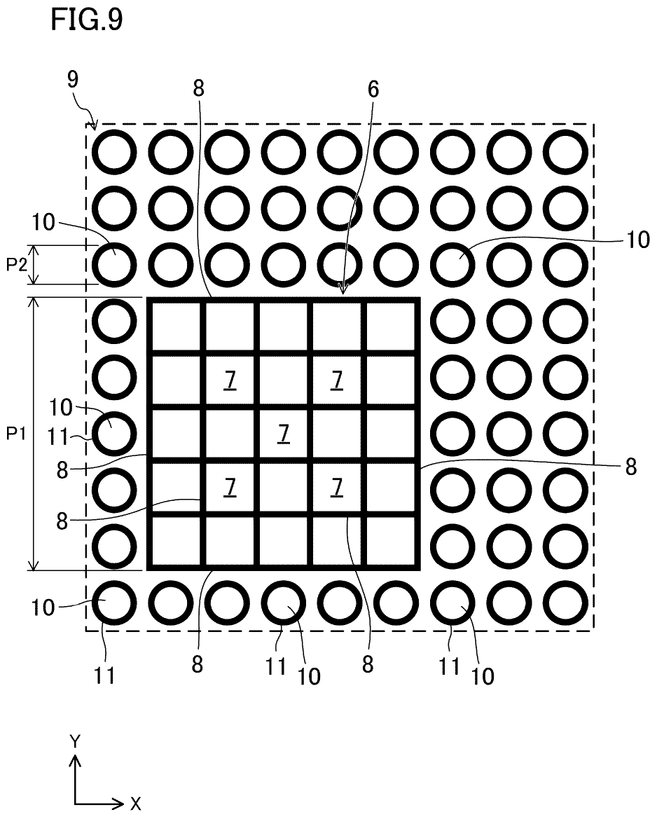

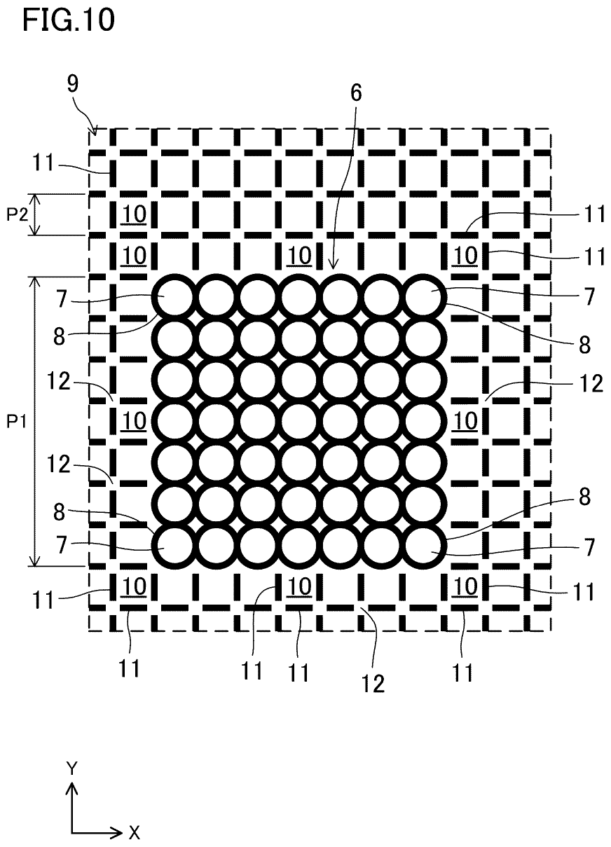

As in a fourth variation illustrated in FIG. 9, only the second conductor pattern 9 shown in the foregoing embodiment may be replaced with the second conductor pattern 9 shown in the third variation. Alternatively, as in a fifth variation illustrated in FIG. 10, only the first conductor pattern 6 shown in the foregoing embodiment may be replaced with the first conductor pattern 6 shown in the third variation.

### [Sixth Variation of Embodiment]

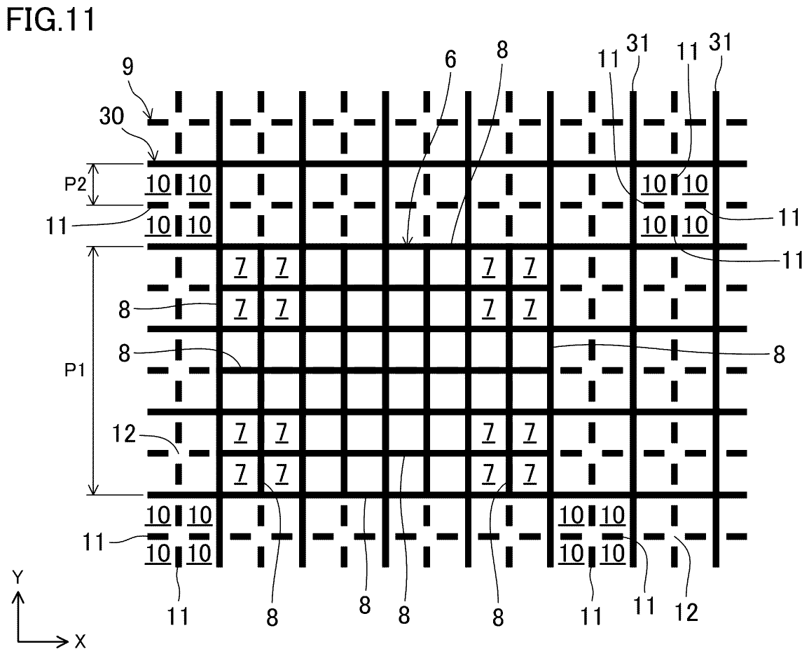

The frequency selective surface 1 according to the foregoing embodiment includes the first conductor patterns 6 and the second conductor pattern 9, but is not limited thereto. For example, as in a sixth variation illustrated in FIG. 11, the frequency selective surface 1 may further include a third conductor pattern 30.

The third conductor pattern 30 is configured to have a lower reflectivity of the electromagnetic waves than the first conductor pattern 6. The third conductor pattern 30 is disposed on the second region R2 of the substrate 2. The third conductor pattern 30 is electrically continuous with the first conductor pattern 6.

The third conductor pattern 30 includes a plurality of third cells. Each of the plurality of third cells is formed by a plurality of third conductive lines 31. The main configuration of the third conductive lines 31 is similar to the configuration of the first conductive lines 8, and detailed description thereof will thus be omitted. In FIG. 11, the reference character that denotes the third cell is omitted for the sake of simplicity.

Each third cell is formed in a closed shape. Each third cell has a substantially square shape. The size of the third cell corresponds to the same size as the size of a combination of four first cells 7 arranged to form a substantially square shape. In other words, the third cell is larger in size than the first cell 7. The plurality of third cells are configured such that the third cells adjacent to each other are electrically continuous with each other.

In this variation, the second conductor pattern 9 and the third conductor pattern 30 are arranged so as to overlap each other in the second region R2. Specifically, in this variation, four second cells 10 are positioned inside the substantially square shape forming one third cell.

In the frequency selective surface 1 of this variation, the first conductor pattern 6 is located in the associated first region R1, and the second conductor pattern 9 and the third conductor pattern 30 coexist in the second region R2. It is thus possible to make the reflectivity of the electromagnetic waves differ between the first region R1 and the second region R2. Further, the coexistence of the second conductor pattern 9 and the third conductor pattern 30 in the second region R2 makes the state of distribution of the conductor patterns on the substrate 2 uniform. That is, the first conductor pattern 6 with relatively higher wiring density of the conductive lines is less conspicuous as compared to the third conductor pattern 30 with relatively lower wiring density of the conductive lines. As a result, if the frequency selective surface 1 is attached to, for example, a window of a building, it is difficult to distinguish the first conductor patterns 6, the second conductor pattern 9, and the third conductor pattern 30 from one another when the window is viewed from the inside or outside of the building. It is thus possible to improve the visibility of the frequency selective surface 1 in this variation as well.

### [Seventh Variation of Embodiment]

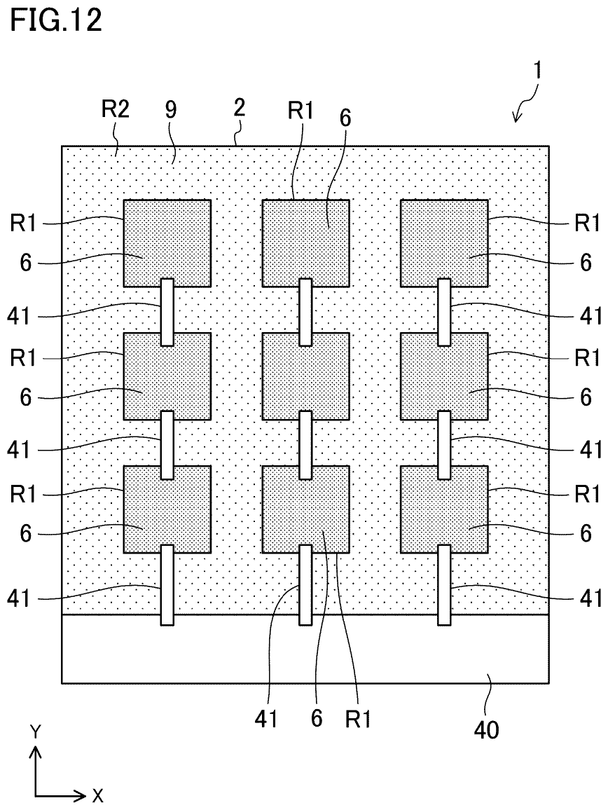

In the foregoing embodiment, the first conductor patterns 6, 6 arranged at predetermined intervals are not electrically continuous with each other due to the second conductor pattern 9, but are not limited thereto. For example, as in a seventh variation illustrated in FIG. 12, a connecting element 41 for electrically connecting the first conductor patterns 6 and an external control circuit 40 may be provided between the first conductor patterns 6, 6 adjacent to each other. The connecting element 41 is made of a variable capacitance diode, for example.

In this variation, the connecting element 41 is provided between the first conductor patterns 6, 6 arranged in the second direction Y. In other words, the first conductor patterns 6, 6 facing each other in the second direction Y are electrically continuous with each other by the connecting element 41. The connecting element 41 is also provided between the first conductor pattern 6 located on the lower side of the sheet of FIG. 12 and the external control circuit 40. Thus, three first conductor patterns 6 aligned along the second direction Y and the external control circuit 40 are electrically connected. This configuration enables appropriate adjustment of the performance of the first conductor patterns 6 in reflecting the electromagnetic waves.

### [Other Embodiments]

The frequency selective surface 1 according to the foregoing embodiment includes the substrate 2 having one film base 3, but is not limited thereto. For example, the substrate 2 may be a multilayer (not shown) in which a plurality of film bases 3 adhere to each other.

The frequency selective surface 1 according to the foregoing embodiment includes the groove forming layer 4 formed on one surface of the film base 3, but is not limited thereto. In other words, the groove forming layer 4 may be provided on the other surface of the film base 3 as well.

The frequency selective surface 1 according to the foregoing embodiment includes the first conductor patterns 6 and the second conductor pattern 9 which are formed on one surface of the substrate 2, but is not limited thereto. In other words, the first conductor patterns 6 may be formed on one surface of the substrate 2, and the second conductor pattern 9 may be formed on the other surface of the substrate 2.

The frequency selective surface 1 according to the foregoing embodiment includes a plurality of first conductor patterns 6, but is not limited thereto. In other words, the frequency selective surface 1 only needs to include at least one first conductor pattern 6.

The frequency selective surface 1 according to the foregoing embodiment includes one second conductor pattern 9, but is not limited thereto. In other words, the frequency selective surface 1 may include a plurality of second conductor patterns 9.

In the foregoing embodiment, the first cells 7 each have a substantially square shape, but not limited thereto. For example, the first cells 7 may each have a substantially rhombic shape. The second cells 10 may also have a substantially rhombic shape instead of the substantially square shape illustrated in the foregoing embodiment.

In the foregoing embodiment, the first conductive lines 8, 8 are arranged at equal intervals in the first direction X or the second direction Y. However, the first conductive lines 8, 8 do not have to be arranged at equal intervals. The second conductive lines 11, 11 do not have to be arranged at equal intervals, either.

The frequency selective surface 1 according to the foregoing embodiment includes the adhesive layer 21 formed in the recessed groove 5, but is not limited thereto. In other words, the conductive layer 22 may be directly formed in the recessed groove 5 without the adhesive layer 21.

The frequency selective surface 1 according to the foregoing embodiment includes the blackened layer 25. However, the blackened layer 25 does not have to be provided.

While the embodiments of the present disclosure have been described above, the present disclosure is not limited thereto and various modifications can be made within the scope of the present disclosure.

### INDUSTRIAL APPLICABILITY

The present disclosure is industrially applicable to a frequency selective surface.

### DESCRIPTION OF REFERENCE CHARACTERS

1: Frequency Selective Surface
2: Substrate
3: Film Base
4: Groove Forming Layer
5: Recessed Groove
6: First Conductor Pattern
7: First Cell
8: First Conductive Line
9: Second Conductor Pattern
10: Second Cell
11: Second Conductive Line
12: Slit
21: Adhesive Layer
22: Conductive Layer
23: Seed Layer
24: Body Layer
25: Blackened Layer
30: Third Conductor Pattern
31: Third Conductive Line
40: External Control Circuit
41: Connecting Element
R1: First Region
R2: Second Region

1. A frequency selective surface comprising:
a substrate having a first region and a second region;
at least one first conductor pattern arranged in the first region of the substrate, the at least one first conductor pattern including a plurality of first cells, each of the first cells being formed by a plurality of first conductive lines; and
at least one second conductor pattern arranged in the second region of the substrate, the at least one second conductor pattern including a plurality of second cells, each of the second cells being formed by a plurality of second conductive lines,
the plurality of first cells being configured such that the first cells adjacent to each other are electrically continuous with each other,
the at least one first conductor pattern being configured such that an overall size of the first conductor pattern is smaller than a wavelength of electromagnetic waves entering the frequency selective surface and is a size capable of reflecting the wavelength of the electromagnetic waves,
the plurality of second cells being configured such that the second conductive lines forming the second cells adjacent to each other are not electrically continuous with each other,
the at least one second conductor pattern being configured such that a size of each of the second cells is smaller than the overall size of the first conductor pattern and is a size capable of transmitting the wavelength of the electromagnetic waves.

2. The frequency selective surface of claim 1, wherein
each of the at least one first conductor pattern and the at least one second conductor pattern is configured to have a total light transmittance of 70% or more, and
each of the plurality of second conductive lines is configured to have a line width of 10 μm or less and a length that is 1/50 or less of the wavelength of the electromagnetic waves.

3. The frequency selective surface of claim 1, wherein
the plurality of second conductive lines are configured to extend along a first direction and a second direction intersecting the first direction, and
a space between an end of the second conductive line extending along the first direction and the second conductive line extending along the second direction is set to be 1 μm or more in the first direction.

4. The frequency selective surface of claim 1, wherein
the substrate is formed in a film shape.

5. The frequency selective surface of claim 4, wherein
at least one outer surface of the substrate has at least one bottomed recessed groove, and
each of the first conductive lines and the second conductive lines includes a conductive layer embedded in the recessed groove.

6. The frequency selective surface of claim 5, wherein
a main component of a conductive material forming the conductive layer of each first conductive line is the same as a main component of a conductive material forming the conductive layer of each second conductive line.

7. The frequency selective surface of claim 5, wherein
each of the first conductive lines and the second conductive lines further includes a blackened layer stacked on the conductive layer on an opening side of the recessed groove.

8. The frequency selective surface of claim 1, wherein
the substrate has a plurality of the first conductor patterns,
the plurality of first conductor patterns are spaced apart from each other on the substrate, and
each of the plurality of first conductor patterns is provided with a connecting element configured to connect electrically each of the plurality of first conductor patterns and an external control circuit.
